(19) United States
(12) Patent Application Publication
(10) Pub. No.: US 2016/0081284 A1
(43) Pub. Date: Mar. 24, 2016

(54) A MODULAR DRAINAGE SYSTEM

(71) Applicant: GreenBlue Urban Ltd, East Sussex (GB)

(72) Inventor: Dean Bowie, East Sussex (GB)

(21) Appl. No.: 14/891,870

(22) PCT Filed: May 14, 2014
(86) PCT No.: PCT/GB2014/051472

§ 371 Date: Nov. 17, 2015

(30) Foreign Application Priority Data
May 17, 2013 (GB) 1308938.8

(51) Int. Cl. A01G 29/00; A01G 27/02

(52) U.S. Cl. CPC A01G 29/00; A01G 27/02

(57) ABSTRACT

A panel (100) for an underground tree pit comprising a tree facing surface and an outward facing surface and including a container (102) located between said surfaces for collecting rain water; at least one water distribution vent (501); tree root deflection means (103); and interconnection means (105) for connecting to at least one further panel.

The present invention relates to a drainage system and particularly to a drainage system for trees in an urban environment, such as a street pavement.

### BACKGROUND

Trees are an important part of the urban landscape, providing multiple benefits, including storm water management, improved air quality, carbon dioxide reduction and psychological benefits for city dwellers. Typically trees in an urban environment are located in tree pits, which provide a volume of soil in a paved area in which a tree may grow. Incorporation of a drainage system is an essential part of urban tree pit design. Traditionally, trees in pavements have their root zones paved over imperviously, such that water cannot pass through the paving to the roots. The tree is thereby deprived access to natural precipitation. The same situation deprives the paved street of needed storm water attenuation.

Another problem with tree pits is the restricted space for the roots, which may cause a phenomenon known as girdling. The presence of drainage mechanisms and other obstacles may result in limited space being available for root growth in a tree pit. As a consequence roots often begin to grow around the main stem of the tree and cut off or restrict the movement of water, plant nutrients and stored food reserves into the tree. Over time, growth of the branches on sides of the plant affected by the girdling is likely to be slowed, leaves may become smaller and have a lighter green colour, fewer leaves may be produced, and eventually branches may begin to die back. Death of the entire plant can occur in a span of five to 20 years and watering, fertilizing and pruning is unlikely to correct the problem. A tree drainage system must therefore provide root management and one such drainage system for a tree pit, including root management, is disclosed in GB2489455. The system discussed therein comprises a trough for receiving rain water or surface run-off together with root directors for guiding the growth of the roots and preventing girdling.

Although the system disclosed in GB2489455 works well, problems remain, for example the arrangement is not suitable when the tree is to be located in a place where the area available for the drainage system is restricted or irregular in shape. Although a modular arrangement, in which sections are fitted together in situ rather than moulded beforehand, might be expected to overcome such difficulties, it is found that problems remain, for example roots grow against the joins of the modular system and force apart the panels.

In addition, it is important for those managing drainage systems to know if the soil around the tree has become saturated, for example flooding has occurred, but this is often difficult to detect. It would be advantageous to have a simple flood warning system to indicate that the soil in a tree pit is saturated.

### SUMMARY OF THE INVENTION

In a first aspect the invention provides a panel for an underground tree pit comprising a tree facing surface and an outward facing surface and including a container located between the tree facing and outward facing surfaces for collecting rain water; at least one water distribution vent; tree root deflection means; and interconnection means for connecting to at least one further panel.

Preferably the at least one water distribution vent is located on said outward facing panel.

Preferably the interconnecting means comprises at least one protrusion on a first end of the panel and at least one corresponding socket on a second end.

Preferably the panel further comprises a mechanism for indicating flood saturated soil, comprising a tube; a plurality of vents; and an indicator, said indicator being less dense than water and freely movable within said tube, such that, in use, said indicator moves in response to a water level. Preferably the panel further comprises a support ledge for supporting a tree pit grille.

According to a second aspect of the present invention, there is provided a drainage system comprising a plurality of interconnected panels as claimed in any preceding claim.

### BRIEF DESCRIPTION OF THE DRAWINGS

The above and other aspects of the invention will now be described by way of example only, with reference to the following drawings in which: from the tree facing side of the panel;

FIG. 1 is a perspective view of a modular panel for a drainage system according to an embodiment of the invention;

FIG. 2 is a perspective view of a tree with roots encountering an obstacle, thus illustrating the problem of root girdling;

FIG. 3 is a perspective view of a modular system without root deflecting ribs, thus illustrating a problem with a modular system without root deflecting ribs;

FIG. 4 is a perspective view of a drainage system constructed from modular panels according to an embodiment of the invention;

FIG. 5 is a perspective view of the panel of FIG. 1, viewed from the opposite side to the view in FIG. 1;

FIG. 6 is a side view of the panel of FIG. 1;

FIG. 7 is a top down view of the panel of FIG. 1;

FIG. 8 is a base view of the panel of FIG. 1;

FIG. 9 is a vertical cross section of the panel of FIG. 1;

FIG. 10 is an exploded view of the upper section of the panel according to an embodiment of the invention;

FIG. 11 is a perspective view of the water flow through the panel of FIG. 1.

### DETAILED DESCRIPTION

In its broadest aspect, the present invention provides a modular system for constructing a drainage system for trees in an urban setting. The system is constructed from discrete panels, which provide building blocks for both simple tree pits and potentially more complex systems. A major advantage of such an arrangement is the flexibility provided to construct tree pits in areas of restricted space, such as a pavement. Each panel acts as a collection system for rain water and surface water, a storage and distribution mechanism for the water, a root management system and a support for tree pit grilles and other surface products.

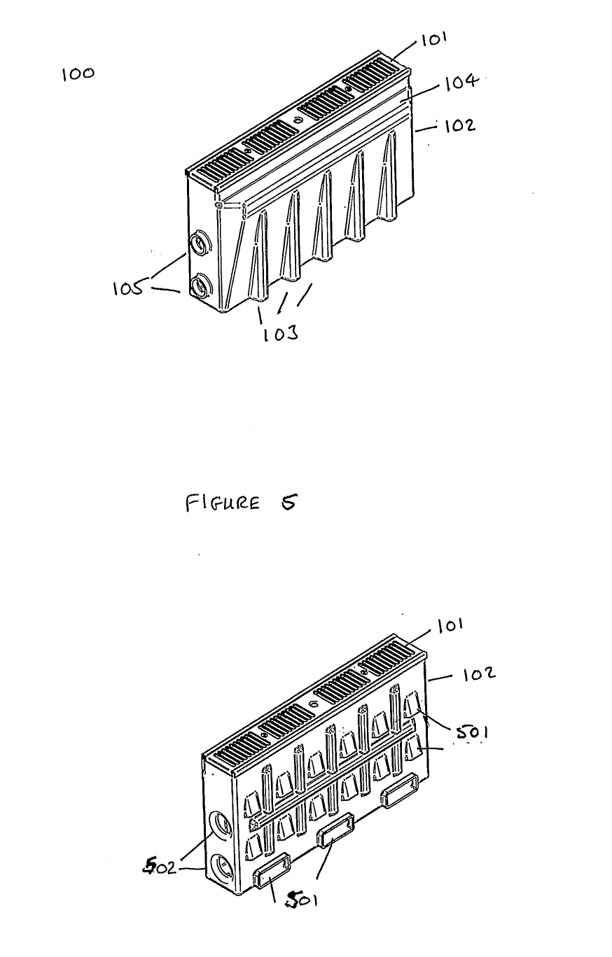

FIG. 1 is a perspective view of a first side of a water collection panel 100 according to an embodiment of the invention. It is a view from the side of the panel, which, in use, would be facing a tree. It comprises a top grille 101, which enables rain water to enter the body of the panel 102. The body of the panel provides a container for receiving and storing rain water and in particular provides a storage for flood water, so that surface water may be quickly drained from a road or pavement surface and has the further advantage that the drained water may be retained therein preventing saturation of the roots of a tree. Root deflecting ribs 103 are provided to guide the direction of growth of tree roots to prevent girdling of the roots and also to guide the roots away from ends of the panel, which, when panels are joined together, will prevent disturbance of the joints of the modular system. These two advantages will be discussed in greater detail below. Support means 104 are provided to support grilles conventionally distributed around a tree over a tree pit, or other surface products. The panels are designed to interconnect with each other, by means of interconnecting protrusions 105 and sockets (not visible). In alternative embodiments of the invention, other methods of joining modular panels, such as clips, to form a drainage system may be employed.

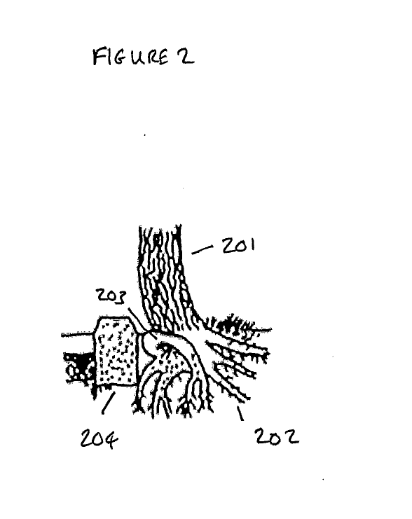

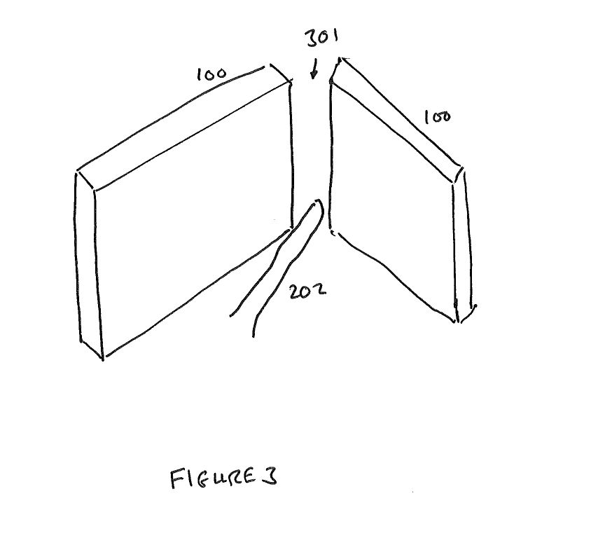

As discussed, the root deflecting ribs 105 have two purposes, they are provided first to prevent root girdling and second to prevent roots growing in the direction of the panel ends, such that when the panels are joined together to surround the tree roots, the roots do not grow into the joins between panels. The problem of root girdling is shown in FIGS. 2. Tree 201 has normally growing roots 202, but has one root 203 which, due to obstacle 204, is girdling. FIG. 3 illustrates the action of root deflecting ribs 103 in directing the roots 202 downwards into the soil below the panels. The root deflecting ribs 103 have the effect of preventing lateral growth of the roots, guiding them downwards into the soil, thus promoting healthy growth. In a preferred embodiment of the invention the root deflecting ribs are substantially perpendicular to the upper surface of the panel. However, the person skilled in the art will appreciate that other arrangements are possible, such as locating the ribs at an acute angle to the panel upper surface. The skilled person will recognise that this and other variants are within the scope of the invention.

FIG. 3 illustrates a problem with a modular system that does not have the benefit of root deflecting ribs. The roots 202 grow towards the panels 100 and if this growth meets joins 301 between the modular panels, they may well force the panels apart. This is one reason modular panel systems have not previously been adopted in the industry. In the present case it has been found that the directed deflection of the roots by the root deflecting ribs ensures that the roots do not force themselves into the joins of the modular panels.

Modular systems allow far greater flexibility in the design and implementation of urban tree drainage systems, and the present mechanism, avoiding growth of tree roots into panel joints, provides a significant advantage over prior art systems. An example of this is illustrated in FIG. 4, which shows an irregular arrangement of panels 100 to provide drainage and root management in a confined pavement area.

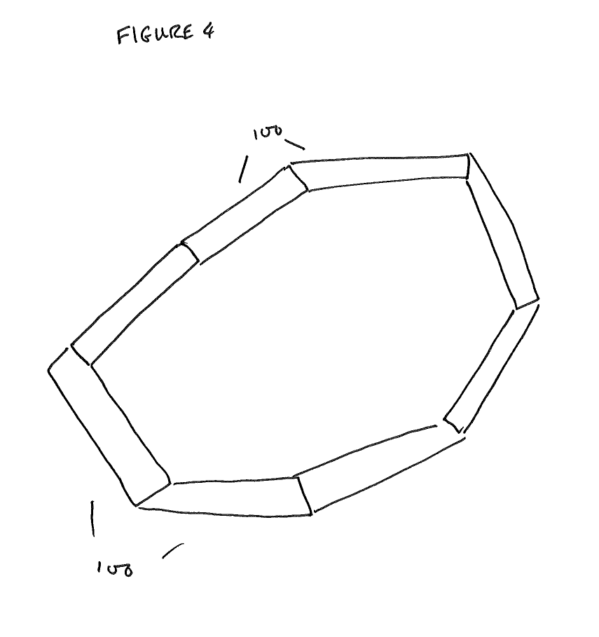

FIG. 5 is a perspective view of the panel of FIG. 1, viewed from the opposite side to that illustrated in FIG. 1. In use, the side of the panel shown in FIG. 5 would be outward facing from a tree. Water dispersing vents 501 are provided to enable controlled distribution of water stored or directed into body 102 of the panel 100. In a preferred embodiment of the invention, sockets 502 corresponding to protrusions 105, illustrated in FIG. 1 are provided. In the preferred embodiment, these sockets interconnect with protrusions to form a join, allowing the construction of a complete drainage system. In the illustrated embodiment, two protrusions and two sockets are shown, with the protrusions being located on a first end of the panel and the sockets being located on a second end of the panel. The person skilled in the art will appreciate that alternative arrangements of the sockets and protrusions are possible and fall within the scope of the invention. For example, the number of protrusions may be varied. Alternatively, a mixture of protrusions and sockets on a first end with a corresponding and complementary mixture of protrusions and sockets on a second end may be provided. The invention is not limited to any specific arrangement of protrusions and sockets.

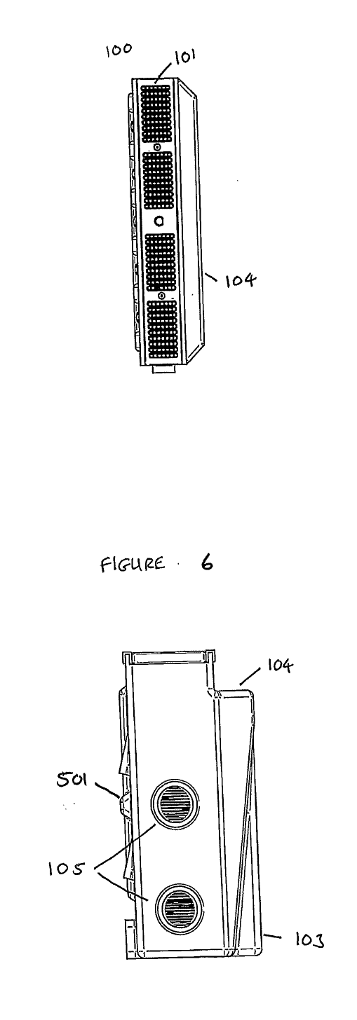

FIG. 6 is a side view of the panel of FIG. 1, showing root deflecting ribs 103, tree grille support ledge 104, connecting sockets 105 and water dispersing vents 501. In a preferred embodiment, the support ledge is located above the root defecting ribs. In an embodiment, the root deflecting ribs provide additional support for the support ledge and hence for the grill or other surface device the ledge is supporting. The person skilled in the art will appreciate that other arrangements for the support ledge are possible, such as its location partially over the main body of the panel, and the invention is not limited to any one such arrangement.

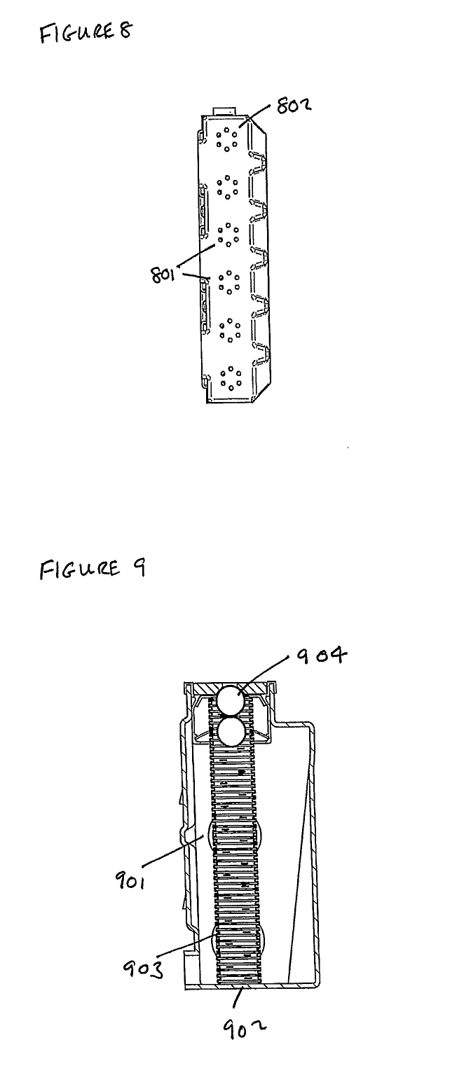

FIG. 7 is a plan view of the panel according to an embodiment of the invention, showing top grille 101 and support ledge 104.

FIG. 8 is a base view of the panel of FIG. 1. Water dispersion vents 801 are provided in the base 802 of the panel. In the embodiment of the invention shown in FIGS. 3 and 6, the water distribution vents are located on the base 802 of the panel and on tree facing surface The location of the dispersing vents enables the distribution of flood water away from the tree pit, thus preventing waterlogging whilst allowing controlled water flow through the pit to provide irrigation of the roots.

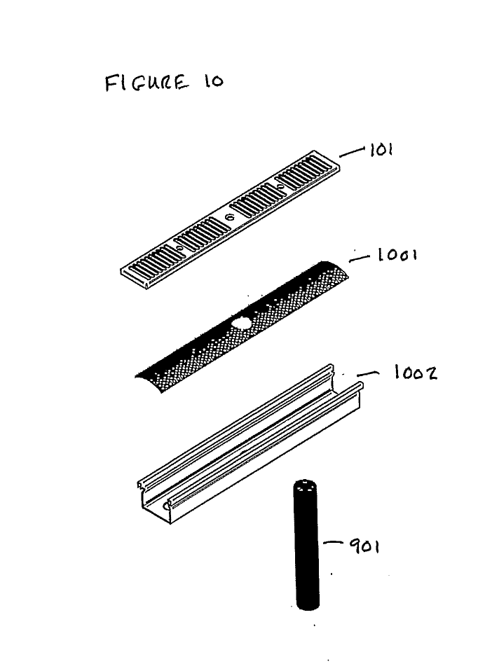

FIG. 9 is a vertical cross section of the panel of FIG. 1, illustrating flood warning indicator 901. Tube 902 is placed within the main body 102 of the panel. Tube 902 is provided with a plurality of vents or perforations 903, to allow water from the main body 102 to flow into the tube, and a floating device 904 which is less dense than water and floats upon the surface of the water. The floating device 904 rises in response to a rising water level and gives warning that a flood has occurred.

The presence of the floating device 904 near to the top of the panel will give an indication that a flood has occurred and that the panel is full. Typically the floating device 904 is spherical, comprises an outer skin light plastic and is filled with air, but the person skilled in the art will appreciate that variants on this are possible, so long as they are less dense than water and capable of providing an indication of the water level, and are within the scope of the invention.

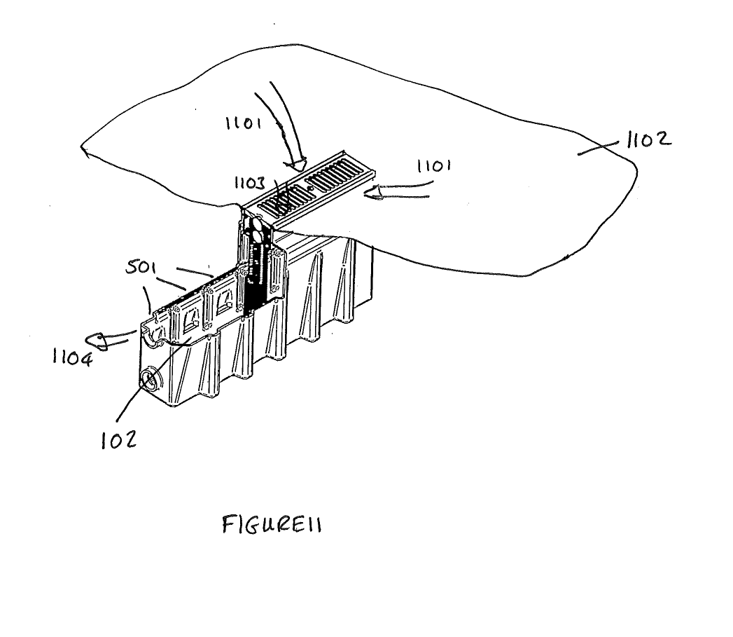

FIG. 10 is an exploded view of the upper section of the panel according to an embodiment of the invention. There is provided grille 101, debris filter 1001, water collection channel 1002 and flood tube 901. The debris filter and water collection channel are provided to prevent the panel filling up with debris such as leaves, soil, thrown away paper etc., which could result in the blocking of the water distribution vents. The person skilled in the art will appreciate that other arrangements to achieve this purpose are possible. An example would be to provide a grille with a very narrow mesh to prevent debris entering the body of the panel. The invention is not limited to any one arrangement to prevent water vent blockage or the entry of debris into the panel body.

In use, the panels are located in the desired position, interconnected using the protrusions and sockets located on the ends of the panels and providing a tree pit for a tree. A tree is then planted within the tree pit with, if required, a conventional tree pit grille around it, supported by support ledge 104. The drainage action of a panel according to the invention is illustrated in FIG. 11. Falling water, rain water or surface run-off 1101 on ground 1102, flows 1103 through upper grille 101, collects in the container 102 and is released controllably 1104 through the water vents 10x, 50x.

The person skilled in the art will appreciate that there are many possible arrangements of water vents, including providing vents on the tree side of the panel, and that the invention is not limited to any one arrangement of vents.

1. A panel for an underground tree pit comprising a tree facing surface and an outward facing surface and including a container located between said surfaces for collecting rain water; at least one water distribution vent; tree root deflection means; and interconnection means for connecting to at least one further panel.

2. A panel as claimed in claim I wherein said at least one water distribution vent is located on said outward facing panel.

3. A panel as claimed in claim 1, wherein said interconnecting means comprises at least one protrusion on a first end of the panel and at least one corresponding socket on a second end.

4. A panel as claimed in claim 1, further comprising warning device for indicating flood saturated soil, comprising a tube; a plurality of vents; and an indicator device, said indicator device being less dense than water and freely movable within said tube, such that, in use, said indicator device moves in response to a water level.

5. A panel as claimed in claim 1 further comprising a ledge for supporting a tree pit grille.

6. A drainage system comprising a plurality of interconnected panels as claimed in claim 1.

7. (canceled)
